(19) United States
(12) Patent Application Publication
(10) Pub. No.: US 2026/0131619 A1
(43) Pub. Date: May 14, 2026

(54) Cooling System for a Motor Vehicle

(71) Applicant: MAHLE International GmbH, Stuttgart (DE)

(72) Inventors: Matthias Jung, Stuttgart (DE); Thomas Strauß, Notzingen (DE)

(21) Appl. No.: 19/279,497

(22) Filed: Jul. 24, 2025

(30) Foreign Application Priority Data
Jul. 26, 2024 (DE) 102024121333.7
Jan. 10, 2025 (DE) 102025100800.0

(51) Int. Cl. B60H 1/00

(52) U.S. Cl. CPC B60H 1/00392; B60H 1/00278; B60H 1/00914; B60H 2001/00307; B60H 2001/00928

(57) ABSTRACT

A cooling system for an electric vehicle is provided. The cooling system includes a cooler circuit, a battery circuit, a chiller circuit, an electrical circuit, and a switching valve, in which the individual circuits can be divided into subsidiary circuits.

### CROSS-REFERENCE TO RELATED APPLICATIONS

This application claims priority from German Patent Application No. 10 2024 121 333.7 filed Jul. 26, 2024, and from German Patent Application No. 10 2025 100 800.0 filed on Jan. 10, 2025, the entirety of each is hereby incorporated by reference herein.

The invention relates to a cooling system for a motor vehicle according to Numbered Paragraph 1, a thermal management module, and a motor vehicle that has such a cooling system or thermal management module.

U.S. Pat. No. 11,807,067 B2 discloses a cooling system for a motor vehicle with an 8-port switching valve with which different coolant circuits can be connected to one another to distribute heat within the vehicle.

The object of the invention is to design a cooling system for a motor vehicle such that the existing heat is used and distributed advantageously in a motor vehicle in a variety of operating modes with as few switching components, and taking up as little space as possible.

A cooling system for an electric vehicle according to the features of Numbered Paragraph 1 and the Numbered Paragraphs that reference Numbered Paragraph 1, as well as a thermal management module with such a cooling system, and a motor vehicle with a cooling system or thermal management system, are therefore proposed herein.

The cooling system obtained with the invention for an electric vehicle has four main coolant circuits that can be connected to one another by a first switching valve that has eight ports. The first switching valve can assume different switching settings, resulting in different connections between the main coolant circuits to one another. These main coolant circuits can also be subdivided into subsidiary circuits.

The valve body in the first switching valve can take the form of a ball or cylinder that rotates about an axis, which has different channels for conducting the coolant. By rotating the valve body in relation to the first switching valve ports, different connections can be obtained. In theory, the desired function can also be obtained with numerous individual multi-port valves. This has the disadvantage that these are significantly more complicated and expensive than a single switching valve with which all of the necessary switching states can be obtained.

The main coolant circuits use the same coolant, normally a mixture of water and glycol. Other coolants can also be used, e.g. low viscosity oil or a special medium designed for the specific use.

The main coolant circuits are a cooler circuit, battery circuit, chiller circuit, and electronics circuit.

The cooler circuit, chiller circuit, and electronics circuit can be subdivided into subsidiary circuits, which can be connected, disconnected, mixed, or even operated in isolation.

The first switching setting S1 connects a first port to a seventh, an eighth port to a second, a fifth port to a third, and a fourth port to a sixth. In this first setting, the return for the chiller circuit is connected to the intake for the battery circuit, and the return for the chiller circuit is then connected to the intake for battery circuit. The return for the cooler circuit is connected to the intake for the electronics circuit, and the return for the electronics circuit is then connected to the intake for the cooler circuit. This connects the battery circuit to the chiller circuit, and the cooler circuit to the electronics circuit.

A second setting S2 connects the first port to the seventh, the fourth port to the second, and the eighth port to the third. This conducts the coolant from the electronics circuit to the cooler circuit, and from there to the battery circuit, where it is then returned to the intake for the electronics circuit.

A third setting S3 connects the first port to the third, the fourth port to the second, the fifth port to the seventh, and the eighth port to the sixth. This connects the electronics circuit and battery circuit to one another. The cooler circuit and chiller circuit are likewise connected to one another.

A fourth setting S4 connects the first port to the second, the fourth port to the sixth, and the fifth port to the third. The electronics circuit then coupled to itself, such that it lets coolant circulate within itself, while the battery circuit and chiller circuit are coupled to one another.

A fifth setting S5 of the first valve connects the first port to the sixth, the fifth port to the second, the fourth port to the third, and the eighth port to the seventh. This disconnects the cooler circuit and battery circuit from the cooling system, resulting in the intakes and outlets of the cooler circuit and battery circuit being connected to themselves. The chiller circuit and electronics circuit are coupled to one another.

In addition to the main coolant circuits, a refrigerant circuit is also necessary in the cooling system. This is composed of at least one compressor, an indirect condenser, a chiller, and at least one, advantageously at least two, adjustable expansion valves, at appropriate locations in the refrigerant circuit. The refrigerant circuit can be operated in a warm pump mode, and thus used to generate heat. This warm pump mode uses heat from a heat source and brings it to a higher energy level in a cyclical process. This type of heat generation is extremely efficient, such that a great deal of heat can be obtained with very little electricity. In modern electric vehicles, R290 (propane) or R774 (CO₂) is used in such a refrigerant system. Other refrigerants, such as R1234yf, can also be used.

Mixing valves, normally 3-way valves that can either connect two ports or three, are used to subdivide the main cooling circuits at nodes therein. The placement of the mixing valves with at least three ports at nodes is substantial to the invention. It is possible to obtain these connections with individual valves in the subsidiary circuits but this requires more parts and is more complex, significantly increasing costs.

There is a coolant cooler in the cooling circuit. Outside air flows through the coolant cooler and discharges heat from the coolant into this air, or the coolant acquires heat therefrom, such that it can be used in a heat pump process. The coolant cooler it is usually in the front part of the motor vehicle such that it is exposed to wind generated through the forward movement of the vehicle. There can also be a fan on the coolant cooler that blows or suctions air through the coolant cooler when the wind generated is insufficient, or if the vehicle is stationary and requires more cooling, e.g. during the charging process. For further control, there can be an opening in the grill of vehicle with adjustable slats that can be opened to obtain a greater cooling effect, or closed if less cooling is needed. When the vehicle is moving, closed slats lower the air resistance and reduce energy consumption.

The cooler circuit also has a first mixing valve in the form of a 3-way valve. This can connect a cooler bypass circuit, such that the coolant can bypass the coolant cooler entirely or partially.

The cooler circuit is therefore composed of two subsidiary circuits, a cooler subsidiary circuit and a cooler bypass circuit.

This allows heat transfer by the coolant cooler to be regulated, or switched off entirely, in certain operating states. The cooler circuit does not have its own water pump. Circulation therein must therefore be obtained through other main coolant circuits or subsidiary circuits connected thereto by the first switching valve.

The battery circuit contains a second heat-emitting component which is normally the battery in the motor vehicle. Consequently this battery circuit may contain heat caused by charging or discharging the battery, or the second heat-emitting component must be heated to reach the ideal operating state, e.g. when it is cold outside. There are therefore two fundamentally different operating states for the battery circuit, cooling or heating in the same main coolant circuit, which must be obtainable with the cooling system. The battery circuit does not have its own water pump, and circulation must therefore be obtained through another main coolant circuit or subsidiary circuit connected thereto by the first switching valve.

The chiller circuit is subdivided into three subsidiary circuits. The three subsidiary circuits contain two water pumps and two check valves.

The first chiller subsidiary circuit is formed by a second mixing valve and a first check valve. The second mixing valve is a 3-way valve, which can be operated as either a 2-way valve, connecting just two ports, or a 3-way valve, thus functioning in the mixed mode. The first chiller subsidiary circuit also contains a first chiller circuit water pump, and its intake and outlet are connected to the sixth and fifth ports of the first switching valve. Consequently, the volumetric flow of the coolant necessary for the cooler circuit and battery circuit, as well as the coolant temperature in the battery circuit, can be regulated, or the battery circuit can be operated as an isolated circuit.

The chiller circuit contains two more subsidiary circuits, second and third subsidiary chiller circuits. The second subsidiary chiller circuit contains a chiller, i.e. a refrigerant-to-coolant heat exchanger, with which heat can be exchanged between the coolant and a refrigerant circuit.

The third subsidiary chiller circuit contains a second chiller circuit water pump, a second check valve, and a first cab heat exchanger. The second and third subsidiary chiller circuits are connected to one another by first and second chiller nodes.

Air in the cab interior flows through the first cab heat exchanger, which it cools with the cold coolant therein. This can also result in condensation of the water in the air, thus dehumidifying the air entering the cab interior, or the air already in the cab interior if the ventilator is operated in the recirculation mode.

The second chiller circuit water pump conveys the coolant exiting the chiller through the second check valve to the first cab heat exchanger, and back to the chiller through the two chiller nodes.

Consequently, the first cab heat exchanger can either be supplied with cold coolant for cooling the air entering the cab, or the cab heat exchanger can transfer exhaust heat from the cab interior or the air entering it from outside to the coolant and supply it to the chiller in the heat pump mode.

The second subsidiary chiller circuit has no other components, and is connected to the third subsidiary chiller circuit and first subsidiary chiller circuit by two chiller nodes. The chiller can thus provide or receive cold coolant or heat for or from the battery circuit, electronics circuit, and cooler circuit.

The electronics circuit is divided into a parallel arrangement of a first heat-emitting component, e.g. power electronics, drive motors, or other heat-emitting electronic components, numerous of which can be interconnected, and an indirect condenser, and contains a first electronics circuit water pump. This results in a first electronics circuit segment, containing the first heat-emitting components, and a second electronics circuit segment, containing the indirect condenser. An indirect condenser is a condenser cooled by coolant, located in the refrigerant circuit. Refrigerant and coolant flow through the indirect condenser, where heat can thus be exchanged between the two media.

The first electronics circuit segment and second electronics circuit segment can thus be supplied in parallel with coolant from the coolant cooler. The coolant flow is thus divided into two subsidiary circuits at the same temperature.

The coolant flows in the first electronics circuit segment through the first heat-emitting components, and transports the heat back to the first switching valve.

The coolant In the first electronics circuit segment flows through an optional electrical coolant heater downstream of the indirect condenser to a third mixing valve, a 3-way valve, which can be operated as either a 2-way valve, connecting just two ports, or a 3-way valve, thus functioning in the mixed mode, where a third electronics circuit segment is formed, which has a second cab heat exchanger and a second electronics circuit water pump, and the connection to the first switching valve is obtained through a third check valve. The second cab heat exchanger is a heating element through which the air entering the cab flows, which can then heat the air for the cab interior.

As a result of the additional third electronics circuit segment, a very small coolant circuit is obtained, with little thermal mass but a great deal of freedom regarding its use through the different connected, disconnected, or mixed modes obtained with the third mixing valve, to control the temperature of the coolant.

This is particularly advantageous, because it results in lower losses to the exterior due to unnecessary heating of large surfaces or masses, which then cannot be used to heat the cab interior. This also advantageously enables a quick heating of the cab interior by the second cab heat exchanger.

The third check valve ensures that the small heating circuit (third electronics circuit segment) functions correctly with the second cab heat exchanger when switched on fully. A mixed mode for controlling the coolant temperature is necessary if the coolant exiting the indirect condenser is too hot for the cab heat exchanger.

The simple structure with the 3-way valve as the third mixing valve and the third check valve thus enables an advantageously broad means of regulating the temperature of the coolant when entering the second cab heat exchanger, e.g. to ensure that the coolant is not too hot at the second cab heat exchanger, as may be the case in an operating mode in which the cab air is dehumidified when the outside temperature is hot, e.g. warmer than 15° C.

In addition to the classic refrigerant circuit, other configurations of the refrigerant circuit may also be of particular advantage. Vapor injection and hot gas bypass configurations enable a particularly effective generation of heat for the indirect condenser, which can then be used to heat the cab interior.

Vapor injection is a functional structure for the refrigerant circuit that substantially improves the efficiency and efficacy thereof. With this method, a sub-flow of the refrigerant liquidized in the indirect condenser is evaporated in a evaporator and sent to the compressor. The rest of the flow is cooled as a result, and sent to the chiller.

A substantial advantage with vapor injection is the increased cooling effect, allowing the refrigerant circuit to more efficiently cool air from outside. Another advantage is the reduction in overheating of the compressor, thus extending its service life and lowering maintenance costs.

This technology also improves performance at low outside temperatures by optimizing evaporation enthalpy, thus maintaining the efficiency of the refrigerant circuit, even in unfavorable conditions. Operation under partial loads is also optimized by vapor injection, resulting in an overall more effective use of energy. Because the refrigerant circuit is used to generate heat for the cab interior, more heat can be generated with these efficiency-increasing measures, such that there is no need for additional heaters in the coolant circuit.

In a concrete embodiment, the refrigerant circuit has additional valves, refrigerant lines, and an additional evaporator where needed, resulting in a better regulation and design of the refrigerant circuit.

A hot gas bypass is another specific control strategy for refrigerant circuits that optimizes operation of the compressor under certain conditions. This involves diverting part of the hot refrigerant coming from the compressor directly into the suction circuit through a bypass upstream of the compressor, instead of it flowing to the indirect condenser downstream of the compressor. The pressure in the refrigerant circuit can be controlled by the hot gas bypass, which is particularly useful with fluctuating loads. It increases the flow through the compressor, effectively providing more electricity for conveying the refrigerant, therefore discharging more heat into the coolant circuit in the indirect condenser. Because this can also be used to heat the cab interior, there is no need for additional heaters in the coolant circuit. In a concrete embodiment, the refrigerant circuit also contains at least on additional valve, as well as refrigerant lines, which result in a better control and design of the refrigerant circuit.

It is possible to integrate a vapor injection and hot gas cycle in the same refrigerant circuit. In this case, either the vapor injection or the hot gas cycle can be used, or both can be operated simultaneously, if this seems to make sense with regard to efficiency. It would also be possible to incorporate just one of them in the refrigerant circuit.

The heat exchangers in the coolant circuits and the refrigerant circuit may differ. They could be made of individual tubes with fins in between them, through which heat is transferred to, or acquired from, the air flowing therebetween. Stacked heat exchangers could also be used, composed of plates that form channels for at least two fluids between them, in particular for the indirect condenser and the chiller. These structures are known, and must be selected and designed for their specific uses and the refrigerants and coolants that are used.

In a particularly advantageous embodiment of the invention, the first switching valve, refrigerant circuit, first chiller water pump, second chiller water pump, chiller, indirect condenser, first mixing valve, second mixing valve, and third mixing valve form a structural unit to obtain a thermal management module. Uniting these components in a thermal management module has advantages regarding installation space. Placing the components close together eliminates the need for long connecting lines. The thermal management module can be placed where it is needed in the vehicle, and only has the connections needed for connecting it to the heat-emitting components that need to be cooled, or to heat exchangers. This thermal management module is also referred to as an indirect system because the refrigerant circuit is limited to the installation space for the thermal management module, such that the cooling and heating of other components within the cooling system is only obtained with coolant. This means that there is no longer any need to conduct refrigerant to an evaporator in the cab for cooling purposes. This also means that the refrigerant circuit can be fairly small, and function with a small amount of refrigerant. In particular, if R290, i.e. propane, is used, this is advantageous, because the highly flammable propane is kept out of the cab interior. In particular in the case of an accident, this source of fire is then outside the cab, giving passengers more time to reach safety. The lower amount of propane used as a refrigerant also reduces the overall burning.

Another major advantage is the flexibility obtained with regard to where the thermal management module is placed within the vehicle, because electric vehicles do not have large internal combustion engines in the front, and thus have more space for other components that would otherwise have to be fit into the space surrounding the internal combustion engine.

It is not possible to definitively describe all the possible designs for the coolant circuits and their components, and the connections and designs of a thermal management module at this point.

There can be a control unit in the vehicle or thermal management module. This control unit can receive signals from temperature sensors and control the functioning of the individual components in the cooling system, e.g. the first switching valve, mixing valves, water pumps, and components in the refrigerant circuit, and thus control and regulate the cooling system obtained with the invention as needed by implementing the various operating states obtained with the invention. This also allows for other vehicle or driver requirements to be taken into account. These can be signals regarding specific driving states, charging, or the current temperature in the cab interior or outside, as well as the intended temperature inside the cab.

A first temperature sensor can be placed advantageously at the output on the chiller. A second can be placed between the third mixing valve and second cab heat exchanger. A third can be placed downstream of the first heat-emitting component. A fourth can be placed upstream of the eighth port on the first switching valve. A fifth can be placed between the sixth port on the first switching valve and the first chiller circuit water pump. It should be noted here that the individual temperature sensors could also be placed elsewhere, for which reason a definitive description of all the possible placements is impossible.

A cooling system of this type can be operated advantageously and in accordance with the invention in a variety of ways, and therefore account for many of the situations normally encountered with a vehicle in various operating states. For this, the cooling system obtained with the invention, and the components therein, in particular the switching valves and pumps, are activated as needed. Sensors, in particular temperature sensors, and a control unit, as well as the necessary control lines, are used for carrying out the switching processes. The cooling system therefore reacts to requirements for the vehicle, current driving situations, or demands on the part of the driver. The appropriate operating state is selected based thereon, and the cooling system is controlled accordingly.

In a first operating state B1, the first switching valve is in the first setting S1. The first mixing valve is set such that coolant only flows through the first cooler subsidiary circuit, resulting in coolant flowing entirely through the coolant cooler. No coolant flows through the cooler bypass circuit.

The second mixing valve is set such that coolant only flows through the bypass segment. The coolant therefore never gets to the chiller. The first chiller water pump is active, causing the coolant to circulate through the battery circuit. The third mixing valve is set such that no coolant flows through the third electronics circuit segment, but does flow through the second electronics circuit segment. The first electronics circuit water pump is active at this point, conveying coolant through the electronics circuit via the indirect condenser. The refrigerant circuit discharges heat from the indirect condenser to the electronics circuit. Because the first setting S1 of the first switching valve couples the electronics circuit to the cooler circuit, heat in the coolant can be discharged through the coolant cooler. Because coolant does not flow through the third electronics circuit segment, the second electronics circuit water pump is inactive. The cab interior is not heated by the second cab heat exchanger at this point.

Coolant flows through the third chiller subsidiary circuit, in which the first cab heat exchanger is located. The second chiller circuit water pump is active for this, and conveys coolant through the chiller and the first cab heat exchanger. The coolant discharges heat in the chiller to the refrigerant circuit. This cools the coolant, such that the cab interior can be cooled.

The cab interior is thus cooled in this first operating mode, and the temperature of the battery is only controlled by the circulation of the coolant, without transferring any heat to other components. The heat discharged by first heat-emitting component in the electronics circuit that requires cooling, and the heat discharged by the indirect condenser in the electronics circuit, is discharged into the exterior by the coolant cooler.

In a second operating state B2, the first switching valve is in the first setting S1. The first mixing valve is set such that coolant only flows through the first cooler subsidiary circuit, resulting in the coolant flowing entirely through the coolant cooler. No coolant flows through the cooler bypass circuit. The second mixing valve is set such that coolant does not flow through the bypass segment, and therefore does flow through the chiller circuit. The first chiller water pump is active, and thus conveys coolant from the battery circuit through the chiller, which is incorporated in the refrigerant circuit. The chiller therefore acquires heat from the battery circuit, thus cooling the second heat-SUBSTITUTE emitting component, i.e. the battery. The second chiller circuit water pump is not in use, and no coolant flows through the third chiller circuit. The cab interior is therefore not supplied with coolant cooled by the chiller, and therefore not cooled.

The third mixing valve is set such that coolant does not flow through the third electronics circuit segment, but is conveyed through the second electronics circuit segment. The first electronics circuit water pump is in use at this point, conveying coolant through the electronics circuit via the indirect condenser. The refrigerant circuit discharges heat in the indirect condenser to the electronics circuit. Because the first switching valve couples the electronics circuit to the cooler circuit in the first setting S1, heat acquired in the coolant can be discharged by the coolant cooler. The second electronics circuit water pump is not in use, and the cab interior is therefore not heated.

In this second operating mode, the cab interior is not air conditioned. It is neither cooled, nor heated. The battery circuit is actively cooled by the refrigerant circuit, and the heat from the refrigerant circuit is discharged through the electronics circuit to the coolant cooler and thus into the exterior. Cooling of the electronics in the electronics circuit is therefore also obtained with the coolant cooler. This second operating state can be implemented when charging the battery while the vehicle is stationary, with no passengers in the cab, such that no air conditioning is necessary, but the battery and electronics require cooling. Because the battery is actively cooled by the refrigerant circuit, it can be cooled adequately during a quick charging process with a high power input, which generates significantly more heat than with a slower charging processes, e.g. using an electrical outlet in one's garage at home. Air circulation at the coolant cooler can also be improved by the fan.

In a third operating state B3, the first switching valve is in the second setting S2. The first mixing valve is set such that coolant only flows through the cooler subsidiary circuit and thus entirely through the coolant cooler. No coolant flows through the bypass cooler.

The second electronics circuit water pump, first chiller circuit water pump, and second chiller circuit water pump are not in use. The cab interior is neither heated nor cooled. The refrigerant circuit is also inactive.

The electronics circuit, battery circuit, and cooler circuit are interconnected by the second setting S2 of the first switching valve, such that coolant cooled by the coolant cooler first flows through the battery circuit, then the electronics circuit, and subsequently back to the cooler circuit, to end up in the coolant cooler. The only active coolant pump is therefore the electronics circuit water pump, which conveys coolant through the three coolant circuits. Refrigerant flows through the indirect condenser, which is in the refrigerant circuit, but acquires no heat. The heat acquired in the battery circuit and electronics circuit is only discharged into the exterior through the coolant cooler.

The cab interior is not air conditioned in this third operating mode. It is neither cooled, nor heated. The battery circuit and electronics circuit are cooled exclusively by the coolant cooler. This operating mode is normally used in a normal charging process for the vehicle, in which low power is used for charging, such that the amount of heat generated by the charging process is much lower than in a quick charging process, or when the external temperature is so low that heat can be effectively discharged through the coolant cooler in this operating mode.

In a fourth operating state B4 and fifth operating state B5, the first switching valve is in the first setting S1. The first mixing valve is set such that coolant only flows through the first cooler subsidiary circuit, and the coolant flows entirely through the coolant cooler. No coolant flows through the cooler bypass circuit. The second mixing valve is set such that coolant can flow through the bypass segment and through the chiller circuit. The second mixing valve can therefore be controlled such that it is possible to adjust the flow level in the chiller circuit. The coolant is conveyed for this by the first chiller circuit water pump. Coolant from the battery circuit can thus be circulated and mixed with colder coolant from the chiller circuit, as needed.

The second chiller circuit water pump, which is in the third chiller subsidiary circuit, and the first cab heat exchanger, which is supplied with coolant, are also active. The second chiller circuit water pump can be adjusted to the cooling needs in the cab interior. Heat in the coolant in the chiller circuit is discharged to the chiller, thus cooling the coolant. The priority for the fourth operating state B4 is cooling the cab with the first cab heat exchanger. The secondary priority is actively cooling the battery circuit with cold coolant from the chiller circuit. The priority for the fifth operating state B5 is cooling the battery. Its secondary priority is cooling the cab.

This can be adjusted as needed, such that when the cab interior is adequately cooled, more cooling can be made available to the battery.

The third mixing valve is set such that no coolant flows through the third electronics circuit segment, but coolant can flow through the second electronics circuit segment. This means that the cab is not heated, for which reason the second electronics circuit water pump is not in use. The first electronics circuit water pump is switched on and conveys coolant from the electronics circuit into the cooler circuit, cooling the coolant with the air in the coolant cooler. The indirect condenser discharges heat from the refrigerant circuit into the electronics circuit. This exhaust heat is thus also cooled by the coolant cooler in the cooler circuit.

The comfort level obtained in the cab interior through air conditioning is given high priority in these fourth and fifth operating states, while still being able to actively cool the battery as needed. As such, when the desired temperature is reached in the cab, more cooling power can be made available to the battery, and when the cab requires further cooling, the battery temperature can be controlled with less coolant and through circulation. The temperature in the cab is controlled by adjusting the second chiller circuit water pump.

If the battery reaches a critical temperature, the cooling of the cab can be reduced briefly until the battery temperature is restored to a noncritical level. This adjustment is always subject to a concrete determination by the system, taking boundary conditions into account, e.g. the thermal mass of the battery, the internal temperature of the battery, as well as the target temperature for the cab interior and the outside temperature. It is also possible to prioritize either the cooling of the battery or the cab.

In a sixth operating state B6, the first switching valve is in the third setting S3. The first mixing valve is set such that coolant only flows through the cooler subsidiary circuit, thus flowing entirely through the coolant cooler. No coolant flows through the bypass cooler. The chiller circuit and cooler circuit are coupled in this sixth operating state B6. The battery circuit and electronics circuit are also connected to one another.

The second mixing valve is set such that no coolant can flow through the bypass segment, while coolant can flow through the chiller circuit. The first chiller circuit water pump is in use and circulates the coolant from the chiller circuit through the cooler circuit. The chiller in the refrigerant circuit and chiller circuit acquires heat from the coolant and cools it. The refrigerant cooler discharges no heat into the exterior, but instead acquires heat therefrom that it can then provide to the chiller. The second chiller circuit water pump is also active, allowing cold coolant to acquire heat from the first cab heat exchanger. The air entering the cab is also cooled at this point.

The third mixing valve is set such that coolant flows through the third electronics circuit segment. This disconnects the third mixing valve from the first electronics circuit segment. The second electronics circuit water pump is active at this point, and circulates the coolant from the indirect condenser, which acquires heat from the refrigerant circuit, to the second cab heat exchanger, to which heat in the air entering the cab is discharged, and then returned to the indirect condenser through the second electronics circuit node. This advantageously results in a particularly small heating circuit that can heat the cab with the heat from the refrigerant circuit. There can also be an electric heater in the third electronics circuit segment that provides more heat to the coolant when necessary.

The first electronics circuit water pump is also active at this point, with which the coolant can be conveyed from the electronics circuit to the battery circuit and back in order to heat the battery with the exhaust heat from the electronics circuit.

The cab interior can be heated and cooled simultaneously in the sixth operating state B6, this dehumidifies the air entering the cab. If this air is cooled by the first cab heat exchanger, water is condensed, and the air is dehumidified. This air then flows through the second cab heat exchanger, and is heated to the desired temperature. This may be necessary for defrosting the windows when it is cold and humid out. The battery is heated with the heat discharged from the electronics circuit, and therefore from the first heat-emitting components, e.g. the power electronics for the drive motors.

In the seventh operating state B7, the first switching valve is in the first setting S1. The first mixing valve is set such that coolant can flow through the cooler subsidiary circuit, and therefore at least part of the coolant can be conducted through the coolant cooler. Some of the coolant can also flow through the cooler bypass circuit by setting the first mixing valve appropriately. The flow of coolant in the coolant cooler can thus be adjusted, such that the cooling effect can be regulated.

The second mixing valve is set such that coolant can flow through the bypass segment and flow at least in part through the chiller subsidiary circuit. The first chiller circuit water pump is active in this case and circulates coolant from the battery circuit into the chiller circuit. Consequently, the battery can be actively cooled by the chiller circuit, depending on the setting of the second mixing valve. The heat emitted by the battery can the also be used as a heat source for the chiller, which then functions as a heat pump and can thus provide heat to the indirect condenser.

The second chiller circuit water pump is also active and conveys cold coolant from the chiller into the first cab heat exchanger to cool the air entering the cab. The heat acquired by this means can then also be used to provide heat to the indirect condenser.

The third mixing valve can be set such that coolant flows through the third electronics circuit segment and can at least partially flow through the second electronics circuit segment. In this case, the coolant can acquire heat from the indirect condenser. This heat can then be discharged by the second cab heat exchanger to the air flowing into the cab. This air is then heated to the desired temperature in the cab. The first electronics circuit water pump in the first electronics circuit segment is active and circulates coolant in the electronics circuit and cooler circuit. Exhaust heat from at least the first heat-emitting component in the electronics circuit can thus be discharged through the coolant chiller. If the heat from the electronics circuit is also to be used as a heat source for the third electronics circuit segment, the cooling effect in the cooler circuit is reduced with the cooler bypass circuit, and heated coolant is then conducted into the second electronics circuit segment by the setting of the third mixing valve.

As in the sixth operating state B6, dehumidification of the air entering from outside can also take place in the seventh operating state B7. The seventh operating state is used when it is warm outside, which requires a different cooling strategy for the active coolant circuits. This may require a stronger cooling effect for the battery, requiring a connection to the chiller circuit to be added. If less cooling is needed for the battery, the addition of the chiller circuit can be regulated with the second mixing valve, such that coolant only circulates around the battery.

In an eighth operating state B8, the first switching valve is in the third setting S3. The first mixing valve is set such that coolant only flows through the cooler subsidiary circuit, and the coolant is thus conducted entirely through the coolant cooler. The second mixing valve is the set such that coolant does not flow through the bypass segment, and thus flows through the chiller circuit. This eighth operating state B8 is primarily used to heat the cab. For this reason, heat is normally obtained in the coolant cooler in this operating state from outside and then conducted to the chiller. The refrigerant is thus in a heat pump mode, using the outside air as a heat source that is provided to the indirect condenser. The second chiller circuit water pump is inactive. The cab is therefore not being cooled.

The third mixing valve is set such that coolant only flows through the third electronics circuit segment. The second electronics water pump is active in this case, and circulates coolant from the indirect condenser through the second cab heat exchanger and again through the second electronics circuit node back to the indirect condenser. This results again in a small active heating circuit for the cab, that acquires heat from the indirect condenser and discharges it into the air entering the cab through the second cab heat exchanger. There can also be an optional electric heater between the indirect condenser and the second cab heat exchanger in this case, with which the coolant can be further heated.

The first electronics circuit water pump is also active, and lets coolant from the electronics circuit circulate through the first switching valve into the battery circuit. This results in heat exchange between the two circuits, such that the electronics circuit can heat the battery circuit when it is cold outside.

In a ninth operating state B9, the first switching valve is in the fourth setting S4. In this case, coolant does not flow through the cooler circuit. The first mixing valve therefore is inactive in this operating mode. The second mixing valve is set such that coolant does not flow through the bypass segment, and therefore flows through the chiller circuit. The chiller circuit and battery circuit are connected to one another in this case. The first chiller circuit water pump conveys coolant from the battery circuit into the chiller circuit and back.

The second chiller circuit water pump is inactive, such that the cab is not being cooled. The refrigerant circuit is in a heat pump mode and therefore uses heat from the battery circuit, which is then discharged through the chiller to the indirect condenser.

The third mixing valve is set such that coolant only flows through the third electronics circuit segment. The second electronics water pump is active in this case, and circulates coolant from the indirect condenser through the second cab heat exchanger and again through the second electronics circuit node back to the indirect condenser. This also results in a small heating circuit for the cab that acquires heat from the indirect condenser and discharges it through the second cab heat exchanger into the air entering the cab. There can also be an optional electric heater between the indirect condenser and the second cab heat exchanger in this case, with which the coolant can be further heated.

The first electronics circuit water pump is also active at this point, and lets coolant from the electronics circuit circulate therein. The first heat-emitting component is therefore only cooled through circulation. The electronics circuit therefore primarily heats itself. This may be of particular interest when starting up the vehicle or when it is cold outside, when more heat can be obtained from the battery than from the exterior through the coolant cooler. The primary goal in this case is to bring all of the components to the desired operating temperature, while also heating the cab, but not primarily to cool these components.

In the tenth operating state B10, the first switching valve is in the third setting S3. The first mixing valve is set such that coolant only flows through the cooler subsidiary circuit, and is therefore conducted entirely through the coolant cooler. The second mixing valve is set such that no coolant flows trough the bypass segment, and thus flows through the chiller circuit. The first chiller circuit water pump is active and conveys coolant from the chiller circuit into the cooler circuit, where the coolant can then exchange heat in the coolant cooler. The refrigerant circuit is then in the heat pump mode and uses the outside air as a heat source while the coolant acquires heat from the coolant cooler and discharges it to the chiller, making it available to the indirect condenser. The second chiller circuit water pump is inactive. Therefore, the cab is also not being cooled in the tenth operating state B10.

The third mixing valve can be set such that coolant flows through the third electronics circuit segment an can at least partially flow through the second electronics circuit segment. The coolant can then acquire heat from the indirect condenser. This heat can subsequently be discharged by the second cab heat exchanger into the air entering the cab. This air is thus heated to the desired temperature for the cab. The second electronics water pump circulates the coolant accordingly.

A small heating circuit is therefore obtained again that acquires heat from the indirect condenser and discharges it into the air entering the cab through the second cab heat exchanger. There can also be an optional electric heater between the indirect condenser and the second cab heat exchanger in this case, with which the coolant can be further heated.

The first electronics circuit water pump is also active and lets coolant circulate from the electronics circuit into the battery circuit through the switching valve. Heat exchange therefore takes place between these two circuits, such that the electronics circuit can heat the battery circuit when it is cold outside.

In the eleventh operating state B11, the first switching valve is in the first setting S1. The first mixing valve is set such that coolant only flows through the cooler subsidiary circuit, conducting it entirely through the coolant cooler. The second mixing valve is the set such that coolant does not flow through the bypass segment, and thus flows through the chiller circuit.

The first chiller circuit water pump is active and conveys coolant from the battery circuit into the chiller circuit and back. The second chiller circuit water pump can be set according to the need for cooling or dehumidifying the air in the cab. This results in an active cooling of the battery with the chiller circuit by discharging heat into the chiller, while cold coolant in the first cab heat exchanger cools air entering the cab.

The third mixing valve can be set such that coolant flows through the third electronics circuit segment and at least partially through the second electronics circuit segment. In this case, the coolant can acquire heat from the indirect condenser. This heat can then be discharged by the second cab heat exchanger into the air entering the cab. This air is thus heated to the desired temperature for the cab. The second electronics circuit water pump circulates the coolant accordingly.

The first electronics circuit water pump is active and circulates coolant in the electronics circuit to the cooler circuit such that the coolant can flow through the coolant cooler. Heat from at least the first heat-emitting component is therefore discharged to the coolant cooler. This may be useful for de-icing the coolant cooler if it has been cooled by the refrigerant circuit in a heat pump mode to the extent that ice has formed. To ensure that the refrigerant circuit can continue to function in the heat pump mode, the ice must first be thawed through a targeted heating of the coolant cooler such that outside air can continue to pass freely through it, and therefore allowing it to continue to function properly. By partially coupling the electronics circuit using the second and third electronics circuit segments, excess heat from the electronics circuit can also be used to heat the cab. The refrigerant circuit, which is operated in the heat pump mode, acquires heat at the chiller from the battery circuit and the first cab heat exchanger, and discharges this to the indirect condenser.

In a twelfth operating state B12, the first switching valve is in the fifth setting S5. The bypass segment is disconnected at the second mixing valve. Because the cooler circuit is disconnected, the first mixing valve is inactive. The third mixing valve separates the first electronics circuit segment from the third electronics circuit segment. The indirect condenser can heat the coolant in the second or third electronics circuit segment and discharge the heat through the second cab heat exchanger to the air entering the cab. This can be used to heat the cab. An optional coolant heater can be used to directly heat the electronics circuit as needed.

The water pumps in the cooling system are active. Because the electronics circuit and chiller circuit are coupled to one another, exhaust heat from the electronics circuit can be used by the chiller in the refrigerant circuit, which can be operated in the heat pump mode.

The third chiller subsidiary circuit can cool air entering the cab using the first cab heat exchanger, which can primarily enable dehumidification of the air entering or recirculating in the cab in this operating mode.

This air is then returned to the desired temperature in the second cab heat exchanger. The second chiller circuit water pump can be adjusted for the necessary dehumidification in this case. Dehumidification may be optional if it is unneeded. In this case, the second chiller circuit water pump is deactivated.

This operating mode enables air conditioning of the cab while also cooling the electronics when the battery does not need to be heated or cooled. This results in a particularly efficient operation of the vehicle.

Further advantageous embodiments of the invention are described below in reference to the drawings. Therein:

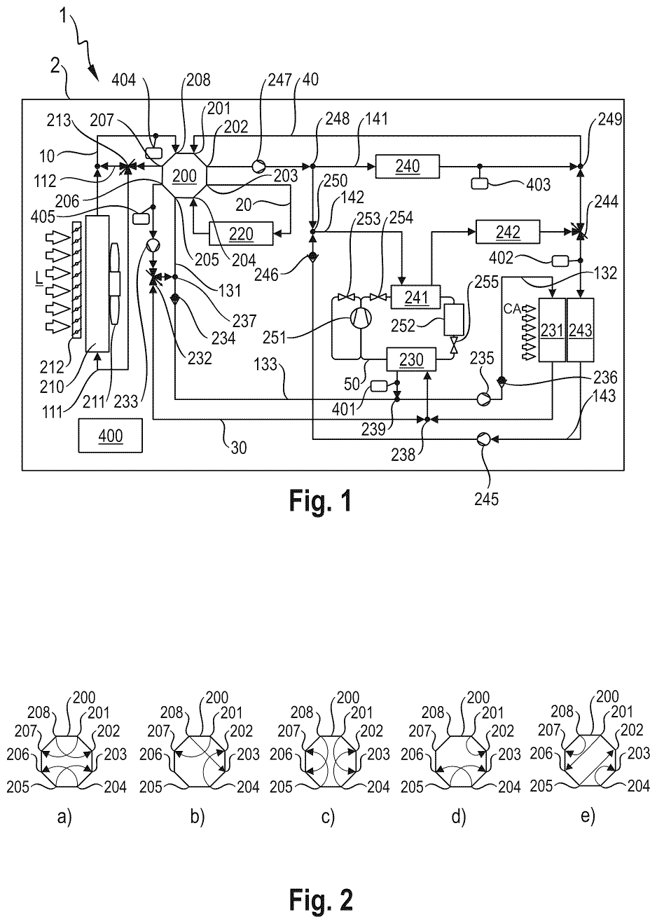

FIG. 1 shows a schematic illustration of the coolant circuit;

FIG. 2 shows a first switching valve with five different settings;

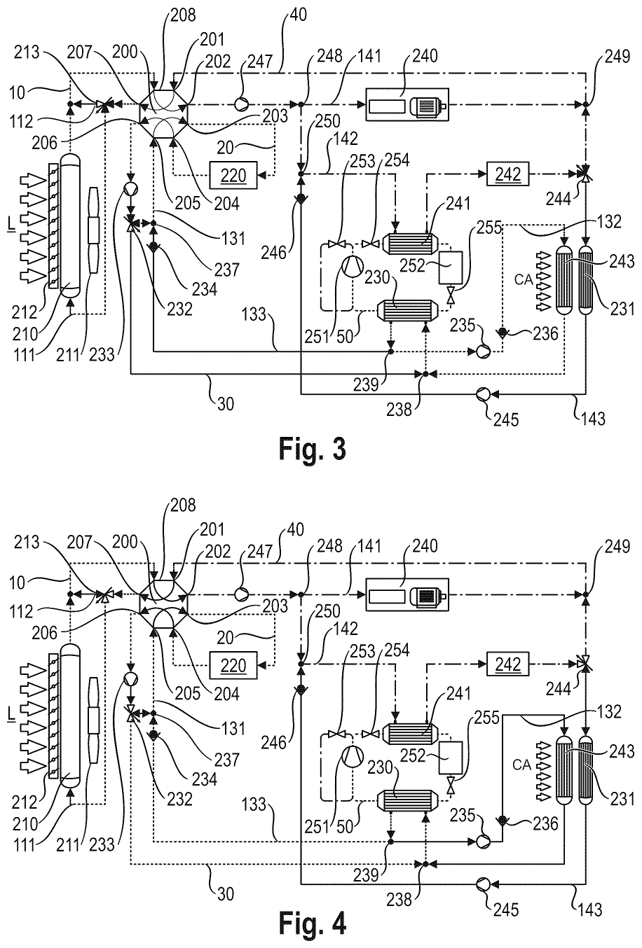

FIG. 3 shows a schematic illustration of the coolant circuit obtained with the invention in a first operating state B1;

FIG. 4 shows a schematic illustration of the coolant circuit obtained with the invention in a second operating state B2;

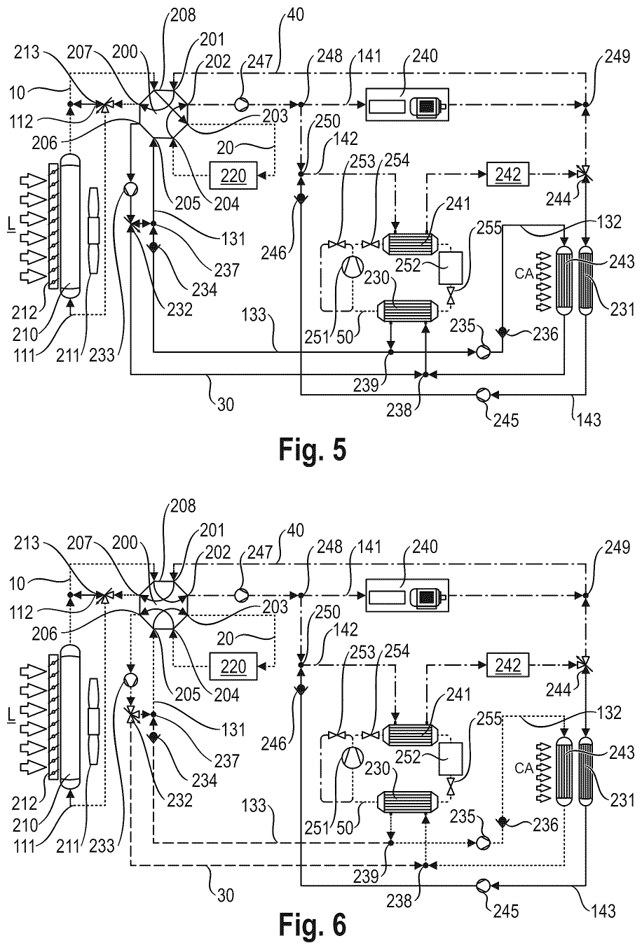

FIG. 5 shows a schematic illustration of the coolant circuit obtained with the invention in a third operating state B3;

FIG. 6 shows a schematic illustration of the coolant circuit obtained with the invention in a fourth operating state B4;

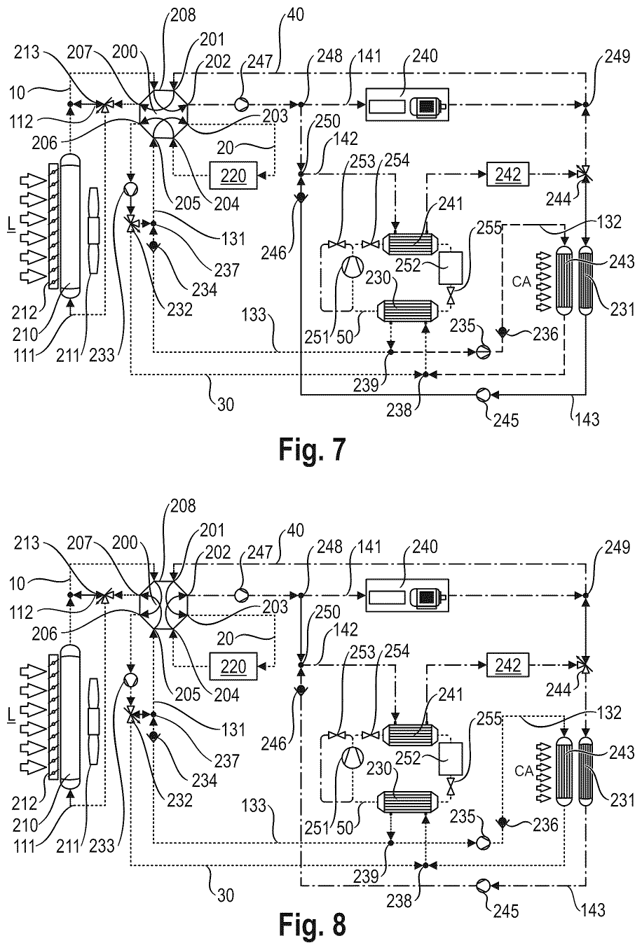

FIG. 7 shows a schematic illustration of the coolant circuit obtained with the invention in a fifth operating state B5;

FIG. 8 shows a schematic illustration of the coolant circuit obtained with the invention in a sixth operating state B6;

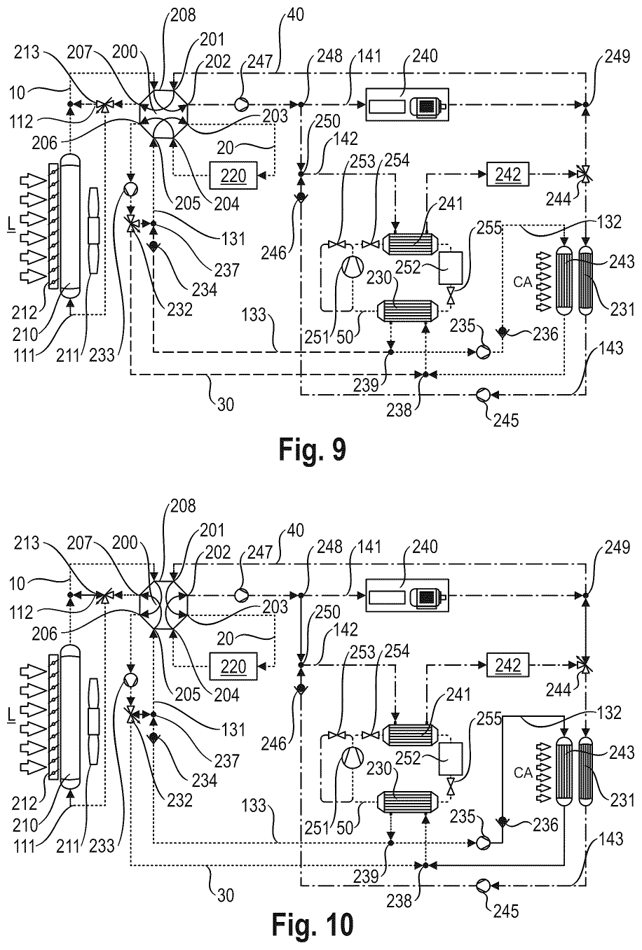

FIG. 9 shows a schematic illustration of the coolant circuit obtained with the invention in a seventh operating state B7;

FIG. 10 shows a schematic illustration of the coolant circuit obtained with the invention in a eighth operating state B8;

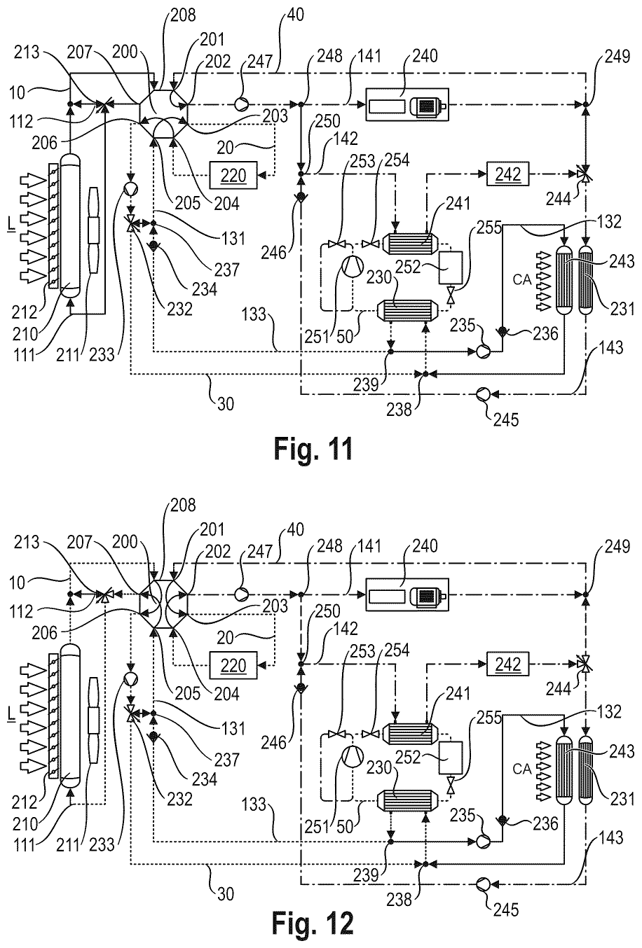

FIG. 11 shows a schematic illustration of the coolant circuit obtained with the invention in a ninth operating state B9;

FIG. 12 shows a schematic illustration of the coolant circuit obtained with the invention in a tenth operating state B10;

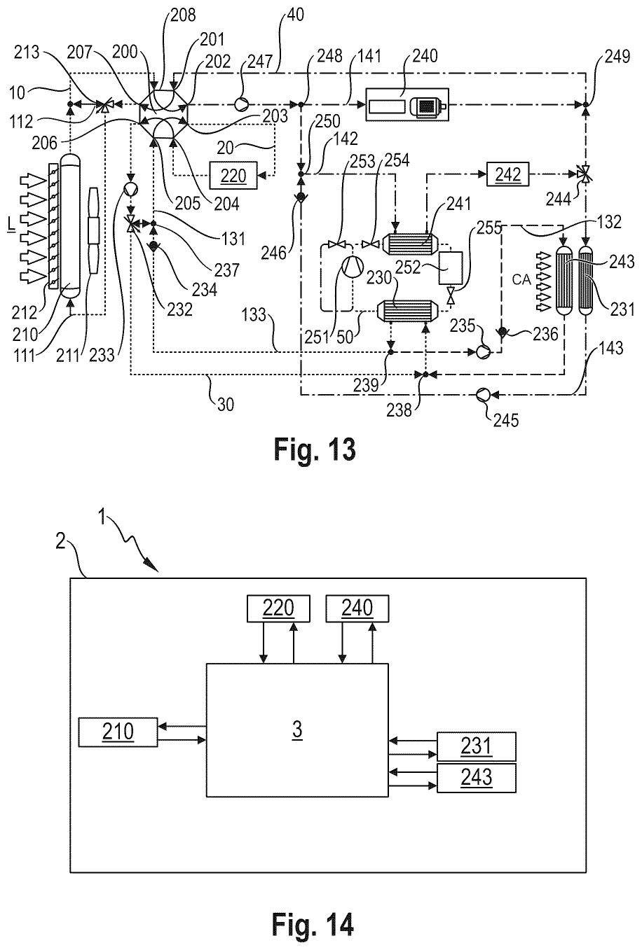

FIG. 13 shows a schematic illustration of the coolant circuit obtained with the invention in a eleventh operating state B11;

FIG. 14 shows a schematic illustration of a thermal management module;

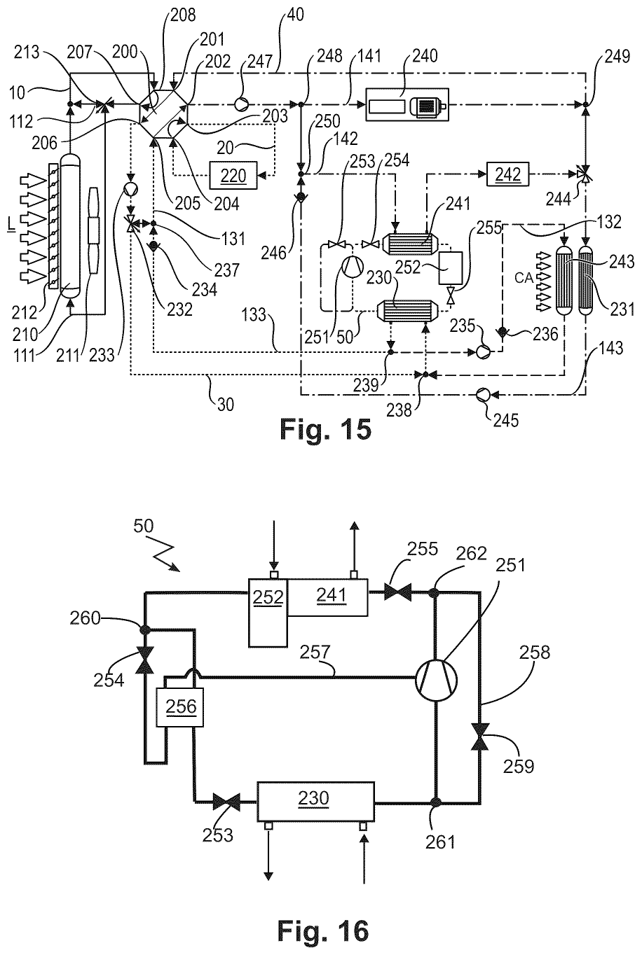

FIG. 15 shows a schematic illustration of the coolant circuit obtained with the invention in a twelfth operating state B12; and

FIG. 16 a schematic illustration of a refrigerant circuit for a cooling system with a hot gas cycle and vapor injection configuration.

Preferred embodiments of the invention:

FIG. 1 shows the schematic structure of a cooling system 1 obtained with the invention in a motor vehicle 2. The cooling system 1 is composed of four main coolant circuits 10, 20, 30, 40, each of which is or can be subdivided into subsidiary circuits. These main coolant circuits 10, 20, 30, 40 are the cooler circuit 10, battery circuit 20, chiller circuit 30, and electronics circuit 40. A central first switching valve 200 has eight ports 201, 202, 203, 204, 205, 206, 207, 208 and can connect the main coolant circuits 10, 20, 30, 40 to one another. The first switching valve 200 can be set to different settings for this, in which the different main coolant circuits 10, 20, 30, 40 can be connected to one another for fluid exchange. The first switching valve 200 is operated electrically with an actuator, and can thus be set to the desired setting. The first switching valve 200 can contain a spherical or cylindrical valve body with channels that rotates about an axis. The connections can be established by rotating the valve body in relation to the ports on the first switching valve 200.

The intake to the cooler circuit 10 is connected to the seventh port 207 on the first switching valve 200. The outlet for the cooler circuit 10 is connected to the eighth port 208 on the first switching valve 200. The cooler circuit 10 has a first mixing valve 213 in the form of a 3-way valve, that divides the cooler circuit into a cooler subsidiary circuit 111 and a cooler bypass circuit 112. The first mixing valve can either connect just two ports, or it can connect three to obtain a mixed mode, conducting coolant into both the cooler subsidiary circuit 111 and the cooler bypass circuit 112. This allows for an adjustment of the cooler circuit 10 to be able to obtain all the possible operating states. There is a coolant cooler 210 in the cooler subsidiary circuit 111 through which outside air can flow. This allows the coolant cooler 210 to discharge heat, or to acquire heat from the outside air when operated in a heat pump mode. To aid in or control heat transfer, there is normally a fan 211, and optionally, slats 212 in front of the cooler, which conduct more or less air toward the coolant cooler 210, depending on the operating requirements. The fan 211 can draw air from outside when the vehicle is stationary, e.g. when charging, and conduct it through the coolant cooler 210, to discharge the exhaust heat from the coolant generated when charging. When moving, the wind may be sufficient, and the slats 212 may be opened or closed to regulate the airflow. This is also the case when the vehicle 2 is stationary, if a greater cooling effect is needed.

The intake in the battery circuit 20 is connected to the third port 203 on the first switching valve 200, and the outlet in the battery circuit 20 is connected to the fourth port 204 on the first switching valve 200. The second heat-emitting component 220 is also in the battery circuit 20, which is normally the battery for the electric vehicle 2.

The outlet in the chiller circuit 30 is connected to the fifth port 205 on the switching valve 200, and the intake in the chiller circuit 30 is connected to the sixth port 206 on the switching valve 200. There is a first chiller circuit water pump 233 downstream of the sixth port 206, and second mixing valve 232 further downstream, with three ports. The second mixing valve 232 is a 3-way valve that either connects two arbitrary ports, or connects all three to obtain a mixed mode. The first chiller circuit water pump 233 is used to let coolant circulate in the chiller circuit 30. Depending on the setting of the first switching valve 200, the first chiller circuit water pump 233 is also used to let coolant circulate in another main coolant circuit 10, 20, 30, 40. The battery circuit 20 therefore does not have its own water pump, and the coolant must therefore be circulated by the first chiller circuit water pump 233, for which the chiller circuit 20 must be connected by the first switching valve 200 to the battery circuit 20.

The second mixing valve 232, downstream of the first chiller circuit water pump 233, connects the outlet in the chiller circuit 30 by means of the bypass segment 237 upstream of the fifth port 205. There is a first check valve 234 in the outlet for the chiller circuit 30 upstream of the bypass segment 237. This forms a first subsidiary chiller circuit 131. The subsidiary chiller circuit 131 allows coolant to circulate through the battery circuit 20 when the second mixing valve 232 is set appropriately, and the battery circuit 20 is connected by the first switching valve 200 to chiller circuit 30. The first check valve 234 prevents return flow of the coolant upstream of the chiller circuit 30.

A second subsidiary chiller circuit 133 is formed downstream of the second mixing valve 232 and upstream of the first check valve 234. A first chiller node 238 is downstream of the second mixing valve 232 in the second subsidiary chiller circuit 133, which is connected to the input on a chiller 230, and a return on the third subsidiary chiller circuit 132. The third subsidiary chiller circuit 132 contains a second chiller circuit water pump 235 and the first cab heat exchanger 231. The first cab heat exchanger 231 is a heat sink through which cold coolant preferably flows, which is used to air condition the cab. Air in the cab and/or from outside flows through the first cab heat exchanger 231, which is then cooled, thus cooling the cab interior. There is a second check valve 236 between the second chiller circuit water pump 235 and the first cab heat exchanger 231, which prevents return flow of the coolant toward the second chiller circuit water pump 235.

The output on the chiller 230 is connected to the second chiller node 239, which is connected to a return on the second subsidiary chiller circuit 133 and an intake for the third subsidiary circuit 132.

The outlet in the electronics circuit 40 is connected to the first port 201 on the first switching valve 200, and the intake in the electronics circuit 40 is connected to the second port 202 on the first switching valve 200.

There is a first electronics circuit water pump 247 downstream of the second port 202, and there is a first electronics circuit node 248 downstream of the first electronics circuit water pump 247, which divides the electronics circuit into a first electronics circuit segment 141 and second electronics circuit segment 142.

The first electronics circuit segment 141 contains a first heat-emitting component 240. This first heat-emitting component 240 is the drive motor or power electronics for the vehicle 2, which must be cooled. This can also comprise numerous components, through which coolant flows successively, and which normally emit heat when in use.

There is a second node 250 in the second electronics circuit segment 142, and there is a third node 249 downstream of the first heat-emitting component 240, which is connected to the first port 201 on the first switching valve 200.

There is an indirect condenser 241 downstream of the second electronics circuit node 250.

The indirect condenser 241 is located with the chiller 230 in a refrigerant circuit 50. An indirect condenser 241 is a condenser cooled with coolant, which normally discharges heat from the refrigerant circuit 50 to the coolant flowing through it.

There is a third mixing valve 244 downstream of the indirect condenser 241, which is a 3-way valve. The third mixing valve 244 can either connect just two ports, or it can connect all three to obtain a mixed mode.

The third mixing valve 244 is connected to the third electronics circuit node 249, and a third electronics circuit segment 143 is formed between the third mixing valve 244 and second electronics circuit node 250.

The third electronics circuit segment 143 contains a second cab heat exchanger 243 and second electronics circuit water pump 245. Like the first cab heat exchanger 231, air entering the cab flows through the second cab heat exchanger 243.

The air normally flows through the first cab heat exchanger 231 first, and is cooled, and then flows through the second cab heat exchanger 243, where it can then be heated to a target temperature. In the winter, when the air normally only needs to be heated, the second cab heat exchanger 243 functions as the heater for the cab. If the air also must be dehumidified, or cooled because it is hot outside, this air is first cooled in the first cab heat exchanger 231.

The second electronics circuit water pump 245 circulates the coolant in this third electronics circuit segment 143. The third electronics circuit segment is reconnected at the second node 250, and there is a third check valve 246 between the second node 250 and second electronics circuit water pump 245. This prevents a return flow of coolant that is to be conducted to the indirect condenser 241, and allows the third electronics circuit segment 143 to be operated separately and in parallel, to heat the cab interior.

To supplement heating of the coolant circulating in the electronics circuit 40, and to quickly heat the cab interior when it is cold outside using the second cab heat exchanger 243, a coolant heater 242 can be placed downstream of the indirect condenser 241 and upstream of the second cab heat exchanger 243. This coolant heater 242 could also be placed elsewhere in the third electronics circuit segment 143, even though the placement upstream of the second cab heat exchanger 243 and downstream of the indirect condenser 241 can be regarded as particularly advantageous.

There can be a control unit 400 for the cooling system 1, which receives signals from temperature sensors 401-405, and sends control signals to the first switching valve 200, the mixing valves 206, 232, 244, and the water pumps 233, 247, 235, 245, as well as the components in the refrigerant circuit 50. Other sensor signals can also be used as the basis for control, e.g. the outside temperature and demands or states of the vehicle.

In a particularly preferred embodiment, a first temperature sensor 401 is placed at the output on the chiller 230. A second temperature sensor 402 is placed between the third mixing valve 244 and second cab heat exchanger 243. A third temperature sensor 403 is placed downstream of the first heat-emitting component 240. A fourth temperature sensor 404 is placed upstream of the eighth port 208 on the first switching valve 200. A fifth temperature sensor 405 is placed between the sixth port 206 on the first switching valve 200 and the first chiller circuit water pump 233. It should be noted that these temperature sensors 401-405 can also be placed elsewhere, for which reason it is impossible to give a definitive list of all the possible installation locations here.

In the embodiment shown in FIG. 1, the chiller 230 and indirect condenser are in a refrigerant circuit 50. This can comprise a compressor 251 with numerous expansion valves 253, 254, 255, and a reservoir 252. The refrigerant circuit uses a typical refrigerant, e.g. R290 or R1234yf, or even R744, enabling heat exchange with the chiller 230 or indirect condenser 241, depending on the operating mode.

FIG. 2 shows the first switching valve 200 in five different settings a), b), c), d) and e), in which the first setting S1 a) connects the first port 201 to the seventh port 207, the eighth port 208 to the second port 202, the fifth port 205 to the third port 203, and the fourth port 204 to the sixth port 206. In this first setting, the return in the chiller circuit 30 is therefore connected to the intake in the battery circuit 20, and the return in the battery circuit 20 is connected to the intake in the chiller circuit 30. The return in the cooler circuit 10 is connected to intake in the electronics circuit 40, and the return in the electronics circuit 40 is the connected to the intake in the cooler circuit 10. This connects the battery circuit 20 to the chiller circuit 30, and the cooler circuit 10 to the electronics circuit 40. The coolant is therefore conducted from the electronics circuit 40 into the cooler circuit 10 and can be cooled therein by the coolant cooler 210. The first electronics circuit water pump 247 is used for this, because the cooler circuit 10 does not have its own water pump. The coolant in the battery circuit 20 is circulated by the first chiller circuit water pump 233, and conducted into the chiller circuit 30. Depending on the settings of the first and second mixing valves 213, 232, the coolant is either distributed to or recirculated in the subsidiary circuits 111, 112, 113 in the cooler circuit 10 or the chiller circuit 30.

The second setting S2 b) connects the first port 201 to the seventh port 207, the fourth port 204 to the second port 202, and the eighth port 208 to the third port 203. This conducts the coolant from the electronics circuit 40 into the cooler circuit 10 and from there to the battery circuit 20, from where it returns to the intake for the electronics circuit 40. The circulation is primarily driven by the electronics circuit water pump 247, and depending on the setting of the mixing valve, the third electronics circuit segment 143 or second electronics circuit segment could also be incorporated, such that the second electronics circuit water pump 245 can also aid in the circulation.

The third setting S3 c) connects the first port 201 to the third port 203, the fifth port 205 to the seventh port 207, and the eighth port 208 to the sixth port 206. This connects the electronics circuit 40 to the battery circuit 20. The cooler circuit 10 and chiller circuit 30 are also connected to one another.

The fourth setting S4 d) connects the first port 201 to the second port 202, the fourth port 204 to the sixth port 206, and the fifth port 205 to the third port 203. The electronics circuit is therefore connected to itself, such that the coolant circulates therein, while the battery circuit 20 and chiller circuit 30 are connected to one another.

The fifth setting S5 e) connects the first port 205 and sixth port 206 to the second port 202, the fourth port 204 to the third port 203, and the eighth port 208 to the seventh port 207. This decouples the cooler circuit 10 and battery circuit 20 from the cooling system 1, i.e. the respective intakes and outlets of the cooler circuit 10 and the battery circuit 20 are connected to themselves. The chiller circuit 30 and electronics circuit 40 are coupled to one another.

FIG. 3 shows a schematic illustration of a first operating state B1 for the cooling system 1 obtained with the invention. This cools the cab interior, and coolant merely flows around the second heat-emitting component 220, i.e. the battery, and the electronics circuit 40 containing the first heat-emitting component 240 and indirect condenser 241 is cooled by the coolant cooler 210.

The first switching valve 200 is in the first setting S1 at this point. The first mixing valve 213 is set such that coolant flows through the coolant cooler 210, and the cooler bypass circuit 112 is not used. The coolant from the electronics circuit 40 is cooled in the coolant cooler 210 by air from outside the vehicle. This discharges the exhaust heat from the first heat-emitting component 240 and the indirect condenser 241. The third mixing valve 244 is set such coolant does not flow through the third electronics circuit segment 143. The chiller circuit 30 and battery circuit 20 are connected to one another. The second mixing valve 232 is set such that coolant only flows through the bypass segment 237, and therefore no coolant flows through the second subsidiary chiller circuit 133.

The second chiller circuit water pump 235 is active, such that coolant flows through the third subsidiary chiller circuit 132 and the chiller 230. Any effect on the first subsidiary chiller circuit 131 is prevented by the setting of the second mixing valve 232 and the first check valve 234. This cools the coolant in the chiller 230, which is then conducted to the first cab heat exchanger 231 with which the air entering the cab is cooled.

FIG. 4 schematically shows a second operating state B2 for the cooling system obtained with the invention. The cab is not air conditioned in this state. The battery circuit is actively cooled by the chiller 230. In addition, the electronics circuit 40, containing the first heat emitting component 240 and indirect condenser 241, is cooled by the coolant cooler 210.

In this state, the first switching valve 200 is in the first setting S1. The first mixing valve 213 is set such that coolant flows through the coolant cooler 210, and the bypass coolant circuit 112 is not used. The coolant from the electronics circuit 40 is cooled in the coolant cooler 210 by air from outside the vehicle. This discharges the exhaust heat from the first heat-emitting component 240 and the indirect condenser 241. The third mixing valve 244 is set such coolant does not flow through the third electronics circuit segment 143.

The chiller circuit 30 and battery circuit 20 are connected to one another. The second mixing valve 232 is set such that no coolant flows through the bypass segment 237, and therefore does flow through the second subsidiary chiller circuit 133. Consequently, the coolant coming from the second heat-emitting component 220, i.e. the battery, can be cooled in the chiller 230. The second heat-emitting component 220 is therefore actively cooled. The second chiller circuit water pump 235 is inactive. The cab is therefore not air conditioned by the first cab heat exchanger 231.

FIG. 5 schematically shows a third operating state B3 of the cooling system 1. This differs from that in FIG. 4 in that the battery circuit 20 is no longer being cooled actively, and instead, the battery circuit 20 is connected to the electronics circuit 40 by the second setting S2 of the first switching valve 200, resulting in the electronics circuit then being cooled by the cooler circuit 10. The chiller circuit 30 is inactive in this operating state.

FIG. 6 schematically shows a fourth operating state B4 of the cooling system 1. This is based on the operating state shown in FIG. 4, but also involves cooling the cab interior, and the active cooling of the battery circuit 20 is regulated by the existing cooling effect obtained with the second mixing valve 232 set for the mixed mode. The first priority here is cooling the cab interior by incorporating the third subsidiary chiller circuit 132 such that cold coolant flows through the first cab heat exchanger 231. If the cooling effect is more than adequate, coolant in the battery circuit 20 can also be cooled by setting the second mixing valve 232 to the mixed mode, therefore conducting the coolant through the chiller 230. The electronics circuit 40 is cooled, as shown in FIG. 4, by the coolant cooler 210 via the cooler circuit 10.

FIG. 7 schematically shows another operating state for the cooling system 1. This cooling state changes the priority of the operating state shown in FIG. 6 from the cab to cooling the battery circuit 20. This is obtained with the second mixing valve 232 such that more coolant is conducted from the battery circuit 20 to the chiller 230, and the performance of the second chiller circuit water pump 235 is regulated to allow less cold coolant to flow from the chiller 230 to the first cab heat exchanger 231. This allows for the cooler coolant generated in the chiller to be effectively used in the vehicle 2.

FIG. 8 schematically shows another operating state of the cooling system 1 obtained with the invention. In this state, the battery circuit 20 is heated by the electronics circuit 40. The cab interior is heated, and the air entering the cab is dehumidified. The refrigerant circuit 50 is operated in the heat pump mode, in which the chiller circuit 30 is connected to the cooler circuit 10 and the coolant cooler is used as a heat source, acquiring heat from outside.

The first switching valve 200 is set to the third setting S3, connecting the electronics circuit 40 to the battery circuit 20. The chiller circuit 30 is connected to the cooler circuit 10. The battery circuit 20 is heated with exhaust heat from the electronics circuit 40. This heats the battery quickly.

The first mixing valve 213 closes off the cooler bypass circuit 112, such that all of the coolant is conducted through the coolant cooler 210. The second mixing valve 232 also closes the bypass segment 237, such that coolant can get to the chiller 230. The heat there is discharged into the chiller 230, resulting in cold coolant at the outlet of the chiller 230, which can get to the first cab heat exchanger 231 through the third subsidiary chiller circuit 132. The air entering the cab can be cooled there, such that the humidity therein can condensate. This dehumidifies the air. The air in the cab can also be at least partially recirculated in this operating state, in order to effectively dehumidify it, so that the windows do not fog up on colder days. The coolant acquires heat in the first cab heat exchanger 231 as a result of the cooling of the air, which can then be used for the heat pump circuit.

The electronics circuit 40 is divided into two subsidiary circuits. The first electronics circuit segment 141 and third electronics circuit segment 143 are thus separated by a specific setting of the third mixing valve 144. Heated coolant in the indirect condenser 241 is then conducted into the second cab heat exchanger 243 in the third electronics circuit segment 143 and second electronics circuit segment 142, and the air entering the cab is heated by this to heat the cab interior. The operating mode shown in FIG. 8 is ideal for heating and dehumidifying in particularly cold weather.

FIG. 9 schematically shows another operating state for the cooling system 1 obtained with the invention, which also functions as a dehumidifying and heating mode like that in FIG. 8, but for when it is not as cold outside.

This operating mode differs from that in FIG. 8 in that the first switching valve 200 is in the first setting S1. Furthermore, the first, second, and third mixing valves 213, 232, and 244 are operated in a mixed mode, depending on the temperatures in the system. This allows heat to be acquired from the battery circuit 20 for the heat pump mode of the refrigerant circuit 50, depending on the temperature of the battery, i.e. the second heat-emitting component 220, in addition to the heat acquired in the first cab heat exchanger 231. The electronics circuit 40 is cooled by the cooler circuit 10, which can be set according to the heat obtained through the first mixing valve 213 in the coolant cooler 210.

FIG. 10 schematically shows another operating state for the cooling system 1 obtained with the invention. This results in heating the cab interior in just a heat pump mode in which the battery is heated with the electronics circuit 40. The only heat source for the heat pump is the outside air, and thus the cooler circuit 10 with the coolant cooler 210.

The first switching valve 200 is in the third setting S3, and the third mixing valve 244 decouples the second electronics circuit segment 142 and the third electronics circuit segment 143 from the rest of the electronics circuit 40, such that they are heated separately by the indirect condenser 241. The acquired heat is discharged into the cab by the second cab heat exchanger 243. The first mixing valve 213 and second mixing valve 232 close off the respective bypass segments 112, 237. The third chiller circuit 132 is inactive. The air in the cab is not cooled. The electronics circuit 40 can also be heated directly by a coolant heater 242 if necessary.

FIG. 11 schematically shows another operating state for the cooling system 1 obtained with the invention. The cab is also heated by the refrigerant circuit 50 functioning in the heat pump mode in this operating mode. The heat pump acquires heat from the battery circuit 20. The first electronics circuit segment 141 in the electronics circuit 40 circulates within itself. The first switching valve 200 is in the fourth setting S4 for this. The third mixing valve 244 separates the first electronics circuit segment 141 from the third electronics circuit segment 143. The indirect condenser 241 heats the coolant in the second electronics circuit segment 142 and third electronics circuit segment 143 and discharges the heat into the air entering the cab through the second cab heat exchanger 243, thus heating it. The cooler circuit 10 with the coolant cooler 210 is inactive in this configuration. The electronics circuit 40 can also be heated directly by a coolant heater 242 if necessary.

FIG. 12 schematically shows another operating state for the cooling system 1 obtained with the invention, in which heating of the cab and the battery are combined.

The first switching valve 200 is in the third setting S3 for this. This connects the battery circuit 20 to the electronics circuit 40. The chiller circuit 30 and cooler circuit 10 are also connected to one another. The coolant cooler 210 acquires heat from outside through the cooler circuit 10, which is then discharged into the refrigerant circuit 50 for the heat pump mode through the chiller 230. The first and second mixing valves 213, 232 disconnect the respective bypass segments 112, 237. The third mixing valve 244 allows the first electronics circuit segment 141 to be connected to the third electronics circuit segment 143 and/or the second electronics circuit segment 142. By connecting the battery circuit 20 to the electronics circuit 40, the battery can then be heated by the exhaust heat from the first heat-emitting component 240 and by the heat generated in the heat pump and discharged by the indirect condenser 241. This can be regulated by the need for heat in the cab and the temperature setting there. There can also be settings with specific priorities, e.g. more heating for the cab or the battery. The electronics circuit 40 can also be heated directly by a coolant heater 242 if necessary.

FIG. 13 schematically shows another operating state for the cooling system 1 obtained with the invention, in which the coolant cooler 210 can be de-iced with exhaust heat from the electronics circuit 40. The first switching valve 200 is in the first setting S1 for this. The cab is consequently heated by the heat discharged by the heat pump via the indirect condenser 241, in which the heat pump acquires heat from the battery circuit 20 and potentially from the first cab heat exchanger 231. It can also be heated by the first electronics circuit segment 141 and the coolant heater 242.

FIG. 14 schematically shows the structure of a thermal management module 3 in a vehicle 2, which forms the cooling system 1. All of the switching and conveying elements for the coolant circuit, and the entire refrigerant circuit 50 are integrated in the thermal management module 3, such that only the first and second heat-emitting components 220, 240, first and second cab heat exchangers 231, 243, and the coolant cooler have to be connected to the thermal management module 3 by connecting lines. This results in a compact cooling system 1 that can be placed in a flexible manner in the vehicle 2.

FIG. 15 schematically shows another operating state for the cooling system 1 obtained with the invention, in which the cab is heated by exhaust heat from the electronics circuit 40, while also being able to dehumidify the air entering the cab. The cooler circuit 10 and battery circuit are disconnected from the cooling system 1.

The first switching valve 200 is in the fifth setting S5. The bypass segment 237 is disconnected by the second mixing valve 232. Because the cooler circuit 10 is not connected to a circuit, the first mixing valve 213 is irrelevant. The third mixing valve 244 separates the first electronics circuit segment 141 from the third electronics circuit segment 143. The indirect condenser 241 heats the coolant in the second electronics circuit segment 142 or third electronics segment 143, and discharges the heat into the air entering the cab through the second cab heat exchanger 243, thus heating it. The electronics circuit 40 can also be heated directly by a coolant heater 242 if necessary.

All of the water pumps 233, 247, 245, 235 are active. Because the electronics circuit 40 and chiller circuit 30 are coupled to one another, the exhaust heat from the electronics circuit can be used in the refrigerant circuit 50, which is in the heat pomp mode, by way of the chiller 230. The third subsidiary chiller circuit 132 enables cooling of the air entering the cab with the first cab heat exchanger 231, which primarily enables dehumidification of the air entering or circulating in the cab. This air is then reheated in the second cab heat exchanger 243. The performance level of the chiller circuit water pump 235 can be adjusted to the necessary dehumidification.

FIG. 16 schematically show a refrigerant circuit 50 for a cooling system 1 that has a hot gas bypass and vapor injection configuration.

The refrigerant circuit 50 is driven by a compressor 251, and heat is discharged into the coolant in the indirect condenser 241 while heat is acquired from the coolant in the chiller 230. A reservoir 252 is used to store the refrigerant. In this embodiment, the reservoir 252 is on the indirect condenser 241. The reservoir 252 can also be placed elsewhere in the refrigerant circuit 50. Refrigerant exiting the indirect condenser 241 or reservoir 252 arrives at a first refrigerant node 260, where it is divided into two streams. A first stream is controlled by a second expansion valve 254, and is conducted to a evaporator 256, and from there in a refrigerant injection line 257 to the compressor. A specific amount of refrigerant can be conducted by the adjustable expansion valve 254 through the evaporator 256 to the compressor 251, and then returned to the refrigerant circuit. refrigerant that is not conducted to the compressor 251, but instead to the chiller 230, is conducted in a separate stream through a separate pathway in the evaporator 256 and then arrives at the chiller 230 through the first expansion valve. Downstream of the chiller, the refrigerant arrives at a second node 261, where it is divided into two streams, one of which leads to the compressor 251, where it is pressurized, while the second of these streams bypasses the compressor via a fourth adjustable expansion valve 259, and subsequently rejoins the refrigerant arriving from the compressor 251 at a third node 262. There is a third adjustable expansion valve 255 downstream of the third node and upstream of the indirect condenser 241. Through the appropriate settings of the expansion valves 253, 254, 255, and 259, the refrigerant circuit can be switched to a vapor injection mode and/or hot gas cycle mode. The refrigerant circuit could also be operated without the vapor injection mode and/or hot gas cycle.

The subject specification is readily understood with reference to the following numbered paragraphs:
Numbered Paragraph 1: A cooling system (1) for an electric vehicle (2), composed of a cooler circuit (10), battery circuit (20), chiller circuit (30), and electronics circuit (40), wherein there is a first switching valve (200) that has a first port (201), second port (202), third port (203), fourth port (204), fifth port (205) sixth (port (206), seventh port (207), and eighth port (208), wherein the cooler circuit (10), battery circuit (20), chiller circuit (30), and electronics circuit (40) can be connected by the first switching valve (200), wherein the intake in the cooler circuit (10) is connected to the seventh port (207), the outlet in the cooler circuit (10) is connected to the eighth port (208), and the cooler circuit has a first mixing valve (213) with three ports with which the cooler circuit can be divided into a cooler subsidiary circuit (111) and a cooler bypass circuit (112), wherein the cooler subsidiary circuit (111) has a coolant cooler (210), wherein an intake in the battery circuit (20) is connected to the third port (203), and an outlet in the battery circuit (20) is connected to the fourth port (204), wherein there is a second heat-emitting component (220) in the battery circuit (20), wherein an outlet in the chiller circuit (30) is connected to the fifth port (205) and an intake in the chiller circuit (30) is connected to the sixth port (206), wherein there is a first chiller circuit water pump (233) downstream of the sixth port (206) and a second mixing valve (232) with three ports downstream of the first chiller circuit water pump (233), wherein a bypass segment (237) connects the second mixing valve (232) to the outlet in the chiller circuit (30) upstream of the fifth port (205), wherein there is a first check valve (234) upstream of the bypass segment (237) in the outlet in the chiller circuit (30), wherein a first subsidiary chiller circuit (131) is formed, wherein a second subsidiary chiller circuit (133) is formed downstream of the second mixing valve (232) and upstream of the first check valve (234), wherein a first chiller node (238) is downstream of the second mixing valve (232) in the second subsidiary chiller circuit (133), which is connected to the input on a chiller (230) and a return in a third subsidiary chiller circuit (132), wherein the output on the chiller (230) is connected to a second chiller node (239), which is connected to a return in the second subsidiary chiller circuit (133) and an intake in the third subsidiary chiller circuit (132), wherein an outlet in the electronics circuit (40) is connected to the first port (201) and an intake in the electronics circuit (40) is connected to the second port (202), wherein there is a first electronics circuit water pump (247) downstream of the second port (202), wherein there is a first electronics circuit node (248) downstream of the first electronics circuit water pump (247), which divides the electronics circuit (40) into two segments, wherein there is a first heat-emitting component (240) in the first electronics circuit segment (141), and there is a second electronics circuit node (250) in the second electronics circuit segment (142), wherein there is a third electronics circuit node (249) downstream of the first heat-emitting component (240), which is connected to the first port (201), wherein there is an indirect condenser (241) downstream of the second electronics circuit node (250), wherein there is a third mixing valve (244) with three ports downstream of the indirect condenser (241), which is connected to the third electronics circuit node (249), wherein a third electronics circuit segment (143) is formed between the third mixing valve (244) and the second electronics circuit node (250).
Numbered Paragraph 2. The cooling system (1) according to Numbered Paragraph 1, characterized in that there is a second chiller circuit water pump (235) downstream of the second chiller node (239), and a second check valve (236) and first cab heat exchanger (231) downstream of the second chiller circuit water pump (235).
Numbered Paragraph 3. The cooling system (1) according to Numbered Paragraph 1 or 2, characterized in that the first mixing valve (213), second mixing valve (232), and third mixing valve (244) are all 3-way valves, which can connect just two paths or three.
Numbered Paragraph 4. The cooling system (1) according to Numbered Paragraph 1, 2 or 3, characterized in that the third electronics circuit segment (143) has a second cab heat exchanger (243), second electronics circuit water pump (245) and third check valve (246).
Numbered Paragraph 5. The cooling system (1) according to any of the preceding Numbered Paragraphs, characterized in that the chiller (230) and indirect condenser (241) are incorporated in a refrigerant circuit (50).
Numbered Paragraph 6. The cooling system (1) according to any of the preceding Numbered Paragraphs, characterized in that there is an electric coolant heater downstream of the indirect condenser (241).
Numbered Paragraph 7. The cooling system (1) according to any of the preceding Numbered Paragraphs, characterized in that the first switching valve (200) connects
   the first port (201) to the seventh port (207), the eighth port (208) to the second port (202), the fifth port (205) to the third port (2039, and the fourth port (204) to the sixth port (206) in the first setting S1,
   the first port (201) to the seventh port (207), the fourth port (204) to the second port (202), and the eighth port (208) to the third port (203) in the second setting S2,
   the first port (201) to the third port (203), the fourth port (204) to the second port (202), the fifth port (205) to the seventh port (207), and the eighth port (208) to the sixth port (206) in the third setting S3, and
   the first port (201) to the second port (202), the fourth port (204) to the sixth port (206), and the fifth port (205) to the third port (203) in the fourth setting S4.
Numbered Paragraph 8. The cooling system according to Numbered Paragraph 7, characterized in that the first switching valve (200) connects the first port (201) to the sixth port (206), the second port (202) to the fifth port (205), the third port (203) to the fourth port (204), and the seventh port (207) to the eighth port (208) in the fifth setting S5.
Numbered Paragraph 9. The cooling system (1) according to any of the preceding Numbered Paragraphs, characterized in that a first temperature sensor (401) is placed at the output on the chiller (230), and/or a second temperature sensor (402) is placed between the third mixing valve (244) and the second cab heat exchanger (243), and/or a third temperature sensor (403) is placed downstream of the first heat-emitting component (240), and/or a fourth temperature sensor (404) is placed upstream of the eighth port (208), and/or a fifth temperature sensor (405) is placed between the sixth port (206) and the first chiller circuit water pump (233).
Numbered Paragraph 10. The cooling system (1) according to any of the preceding Numbered Paragraphs, characterized in that there is a control unit (400), that regulates the valves (200, 213, 244, 232), the refrigerant circuit (50), and the water pumps (233, 247, 235, 245) based on the values obtained from the temperature sensors (401, 402, 403, 404, 405) and the heating or cooling requirements for the cab.
Numbered Paragraph 11. A thermal management module (3) that has a cooling system according to Numbered Paragraphs 1 to 9, characterized in that at least the first switching valve (200), the refrigerant circuit (50), the first chiller circuit water pump (233), the second chiller circuit water pump (235), the chiller (239), the indirect condenser (241), the first mixing valve (213), the second mixing valve (232), and the third mixing valve (244) form a structural unit for a thermal management module (3).
Numbered Paragraph 12. A motor vehicle (2) that has a thermal management module (3) according to Numbered Paragraph 11, or a cooling system (1) according to Numbered Paragraphs 1 to 10.

### LIST OF REFERENCE SYMBOLS

1 cooling system
2 motor vehicle
3 thermal management module
10 cooler circuit
20 battery circuit
30 chiller circuit
40 electronics circuit
50 refrigerant circuit
111 cooler subsidiary circuit
112 cooler bypass circuit
131 first subsidiary chiller circuit
132 third subsidiary chiller circuit
133 second subsidiary chiller circuit
141 first electronics circuit segment
142 second electronics circuit segment
143 third electronics circuit segment
200 first switching valve
201 first port
202 second port
203 third port
204 fourth port
205 fifth port
206 sixth port
207 seventh port
208 eighth port
210 coolant cooler
211 fan
212 slats
213 first mixing valve
220 second heat-emitting component
230 chiller
231 first cab heat exchanger
232 second mixing valve
233 first chiller circuit water pump
234 first check valve
235 second chiller circuit water pump
236 second check valve
237 bypass segment
238 first chiller node
239 second chiller node
240 first heat-emitting component
241 indirect condenser
242 electric coolant heater
243 second cab heat exchanger
244 third mixing valve
245 second electronics circuit water pump
246 third check valve
247 first electronics circuit water pump
248 first electronics circuit node
249 third electronics circuit node
250 second electronics circuit node
251 compressor
252 reservoir
253 first expansion valve
254 second expansion valve
255 third expansion valve
256 evaporator
257 refrigerant injection line
258 refrigerant bypass line
259 fourth expansion valve
260 first refrigerant node
261 second refrigerant node
262 third refrigerant node
400 control unit
401-405 first through fifth temperature sensors
L exterior air inflow
C cab airflow

1-12. (canceled)

13. A cooling system for an electric vehicle, comprising a cooler circuit, a battery circuit, a chiller circuit, and an electronics circuit, further comprising a first switching valve that has a first port, a second port, a third port, a fourth port, a fifth port, a sixth (port, a seventh port, and an eighth port, wherein the cooler circuit, battery circuit, chiller circuit, and electronics circuit are configured to be connected by the first switching valve,
wherein an intake in the cooler circuit is connected to the seventh port, an outlet in the cooler circuit is connected to the eighth port,
wherein the cooler circuit comprises a first mixing valve with three ports with which the cooler circuit can be divided into a cooler subsidiary circuit and a cooler bypass circuit, wherein the cooler subsidiary circuit comprises a coolant cooler,
wherein an intake in the battery circuit is connected to the third port, and an outlet in the battery circuit is connected to the fourth port,
wherein the battery circuit comprises a second heat-emitting component,
wherein an outlet in the chiller circuit is connected to the fifth port and an intake in the chiller circuit is connected to the sixth port,
further comprising a first chiller circuit water pump downstream of the sixth port and a second mixing valve with three ports downstream of the first chiller circuit water pump, wherein a bypass segment connects the second mixing valve to the outlet in the chiller circuit upstream of the fifth port, further comprising a first check valve upstream of the bypass segment in the outlet in the chiller circuit, wherein a first subsidiary chiller circuit is formed, wherein a second subsidiary chiller circuit is formed downstream of the second mixing valve and upstream of the first check valve, wherein a first chiller node is downstream of the second mixing valve in the second subsidiary chiller circuit, which is connected to the input on a chiller and a return in a third subsidiary chiller circuit, wherein the output on the chiller is connected to a second chiller node, which is connected to a return in the second subsidiary chiller circuit and an intake in the third subsidiary chiller circuit, wherein an outlet in the electronics circuit is connected to the first port and an intake in the electronics circuit is connected to the second port,
further comprising a first electronics circuit water pump downstream of the second port, and a first electronics circuit node downstream of the first electronics circuit water pump, the first electronics node divides the electronics circuit into two segments,
further comprising a first heat-emitting component in the first electronics circuit segment, and a second electronics circuit node in the second electronics circuit segment, and a third electronics circuit node downstream of the first heat-emitting component, which is connected to the first port,
further comprising an indirect condenser downstream of the second electronics circuit node, and a third mixing valve comprising three ports downstream of the indirect condenser, which is connected to the third electronics circuit node, wherein a third electronics circuit segment is formed between the third mixing valve and the second electronics circuit node.

14. The cooling system according to claim 13, further comprising a second chiller circuit water pump downstream of the second chiller node, and a second check valve and first cab heat exchanger downstream of the second chiller circuit water pump.

15. The cooling system according to claim 13, wherein the first mixing valve, second mixing valve, and third mixing valve are each 3-way valves, which can connect just two paths or three.

16. The cooling system according to claim 13, wherein the third electronics circuit segment comprises a second cab heat exchanger, a second electronics circuit water pump, and a third check valve.

17. The cooling system according to claim 13, wherein the chiller and indirect condenser are incorporated in a refrigerant circuit.

18. The cooling system according to claim 13, further comprising an electric coolant heater downstream of the indirect condenser.

19. The cooling system according to claim 13, wherein the first switching valve connects
the first port to the seventh port, the eighth port to the second port, the fifth port to the third port, and the fourth port to the sixth port in a first setting (S1),
the first port to the seventh port, the fourth port to the second port, and the eighth port to the third port in a second setting (S2),
the first port to the third port, the fourth port to the second port, the fifth port to the seventh port, and the eighth port to the sixth port in a third setting (S3), and
the first port to the second port, the fourth port to the sixth port, and the fifth port to the third port in a fourth setting (S4).

20. The cooling system according to claim 19, wherein the first switching valve connects the first port to the sixth port, the second port to the fifth port, the third port to the fourth port, and the seventh port to the eighth port in a fifth setting (S5).

21. The cooling system according to claim 13, wherein a first temperature sensor is placed at the output on the chiller, and/or a second temperature sensor is placed between the third mixing valve and the second cab heat exchanger, and/or a third temperature sensor is placed downstream of the first heat-emitting component, and/or a fourth temperature sensor is placed upstream of the eighth port, and/or a fifth temperature sensor is placed between the sixth port and the first chiller circuit water pump.

22. The cooling system according to claim 13, further comprising a control unit (400), that is configured to regulate the valves, the refrigerant circuit, and is configured to regulate the water pumps based on the values obtained from the temperature sensors and the heating or cooling requirements for the cab.

23. A thermal management module comprising a cooling system according to claim 13 wherein at least the first switching valve, the refrigerant circuit, the first chiller circuit water pump, the second chiller circuit water pump, the chiller, the indirect condenser, the first mixing valve, the second mixing valve, and the third mixing valve form a structural unit for a thermal management module (3).

24. A motor vehicle comprising the thermal management module according to claim 23.

25. A motor vehicle comprising the cooling system according claim 13.
